(19) United States
(12) Patent Application Publication
(10) Pub. No.: US 2026/0081212 A1
(43) Pub. Date: Mar. 19, 2026

(54) COMPOUND FOR A SOLID-STATE BATTERY ELECTROLYTE

(71) Applicant: Microsoft Technology Licensing, LLC, Redmond, WA (US)

(72) Inventors: Chi CHEN, Renton, WA (US); Matthias TROYER, Zurich (CH); Brian Allen BILODEAU, Redmond, WA (US); Nathan Andrew BAKER, Kennewick, WA (US); Dennis Wai-Ching TOM, Redmond, WA (US)

(21) Appl. No.: 18/890,202

(22) Filed: Sep. 19, 2024

(51) Int. Cl. H01M 10/0562; C01G 25/00

(52) U.S. Cl. CPC H01M 10/0562; C01G 25/006; C01P 2002/72; C01P 2006/40; H01M 2300/008

(57) ABSTRACT

Disclosed herein is the compound (NaₓLi₃₋ₓ)_{(3-y)/3}Y_{1-y}Zr_{y}Cl₆, where x is greater than 0 and less than 3 and where y is greater than 0 and less than 1. Where x=1 and y=0.75, the compound is Na_{0.75}Li_{1.5}Y_{0.25}Zr_{0.75}Cl₆. The compound is usable as an effective solid electrolyte for a solid-state battery. The solid electrolyte can utilize lithium ions and/or sodium ions as charge carriers.

### STATEMENT REGARDING GOVERNMENT INTEREST

This invention was made with government support under DE-AC05-76RL01830 awarded by the U.S. Department of Energy to Battelle Memorial Institute, Pacific Northwest Division, operator of the Pacific Northwest National Laboratory (PNNL). The government has certain rights in the invention pursuant to Research & Development Services Agreement 81614 between Applicant and Battelle Memorial Institute, Pacific Northwest Division.

### BACKGROUND

Lithium-ion batteries are commonly used to power electronic devices, including consumer electronic devices and electric vehicles (EVs). Conventional lithium-ion batteries include liquid electrolytes. These liquid electrolytes are conventionally comprised of flammable liquid organic compounds. In cases of over-charging or short circuiting, for example, a conventional lithium-ion battery with a liquid electrolyte can become a safety and fire hazard.

Solid-state batteries can potentially provide improvements over conventional liquid electrolyte lithium-ion batteries, such as enhanced safety, thermal stability, energy density, power density, faster charging times, and/or a broader working temperature range relative to conventional lithium-ion batteries. With respect to safety, the non-flammable solid electrolytes of solid-state batteries reduce the risk of fires and explosions compared to the flammable liquid electrolytes in traditional batteries. Additionally, solid-state batteries are less prone to thermal runaway, a condition where increased heat leads to uncontrollable reactions, making them safer for consumer electronics and automotive applications. The higher energy density of solid-state batteries allows for a more compact design and/or longer battery duration. Solid-state batteries also have potential for faster charging times relative to conventional liquid electrolyte lithium-ion batteries.

While most solid-state battery research to date has been directed to solid-state lithium-ion batteries, solid-state batteries that utilize sodium as charge carrier also have potential benefits. Solid-state lithium-ion batteries generally have a higher energy density compared to solid-state sodium batteries; however, sodium is more abundant and less expensive than lithium. Solid-state sodium batteries are thus potentially useful where lower charge capacity and/or larger battery sizes are acceptable.

However, several challenges remain in the development of effective and widely adoptable solid-state lithium-ion and/or sodium-ion batteries. In particular, such batteries benefit from a solid electrolyte that can provide sufficient ionic conductivity, electrochemical stability, mechanical stability, thermal stability, chemical compatibility with anode and cathode materials, manufacturability, and cost-effectiveness.

### SUMMARY

Disclosed herein is the compound:

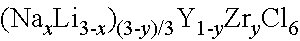

where x is greater than 0 and less than 3 and where y is greater than 0 and less than 1. For example, where x=1 and y=0.75, the compound is:

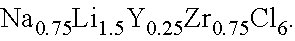

The compound is usable as an effective solid electrolyte for a solid-state battery. The solid electrolyte can beneficially utilize lithium ions and/or sodium ions as charge carriers and is therefore useful as a solid electrolyte in a solid-state lithium-ion battery, a solid-state sodium-ion battery, or a hybrid solid-state battery that utilizes both lithium ions and sodium ions as charge carriers.

Other derivatives of the compound may additionally or alternatively be utilized as a solid electrolyte. Given the general formula NaₖLiₗYₘZrₙClₚ, values of k, l, m, n, and p can be selected to provide charge balance and a stable electrolyte structure. For example, values can be selected to be within: k<3; 0<l; m<1; 0<n; 0<p<6. Although particular examples disclosed herein relate to (NaₓLi₃₋ₓ)_{(3-y)/3}Y_{1-y}Zr_{y}Cl₆ (0<x<3; 0<y<1), including Na_{0.75}Li_{1.5}Y_{0.25}Zr_{0.75}Cl₆, it will be understood that related features and components (e.g., cathode materials, anode materials, etc.) can also be utilized with the other derivatives disclosed herein.

The disclosed compound can exhibit characteristics beneficial for solid-state battery electrolyte applications. Such characteristics include, for example, effective ionic conductivity (including room temperature conductivity), formability/ductility, oxidation/reduction stability, and compatibility with anode and cathode materials.

The solid electrolyte may be a multi-component solid electrolyte. That is, the solid electrolyte can include a first section that includes a first solid electrolyte and a second section that includes a second, different solid electrolyte. The first and second solid electrolytes can be selected to minimize reactions at the interfaces with the respective electrodes to which they contact. For example, the first solid electrolyte can be formulated to interface with a sodium-based electrode while the second solid electrolyte can be formulated to interface with a lithium-based electrode. In some embodiments, the multi-component solid electrolyte can comprise a first solid electrolyte that includes the compound (NaₓLi₃₋ₓ)_{(3-y)/3}Y_{1-y}Zr_{y}Cl₆ (0<x<3; 0<y<1) and/or the compound NaₓLi₃₋ₓYCl₆ (0<x<3) and a second electrolyte that is different from the first electrolyte.

Also disclosed herein is a solid-state battery that includes the solid electrolyte. The solid-state battery can be configured as a lithium-ion battery, a sodium-ion battery, or a hybrid battery capable of using both lithium and sodium ions as charge carriers. In some solid-state battery embodiments that include a multi-component solid electrolyte, the first solid electrolyte can be formulated to interface with a sodium-based electrode and the second solid electrode can be formulated to interface with a lithium-based electrode. Such a solid-state battery can be configured to operate with the lithium-based electrode as the anode and the sodium-based electrode as the cathode.

Also disclosed herein is a method of using a solid electrolyte, comprising: providing an electric potential between a first point and a second point, wherein a solid electrolyte is disposed between the first point and the second point, and wherein the solid electrolyte comprises the compound (NaₓLi₃₋ₓ)_{(3-y)/3}Y_{1-y}Zr_{y}Cl₆ (0<x<3; 0<y<1).

Also disclosed herein is a method of manufacturing a solid-state battery, comprising: placing a positive electrode within a container; placing a negative electrode within the container; and placing a solid electrolyte within the container between and in conductive contact with the positive electrode and the negative electrode. The solid electrolyte can comprise the compound (NaₓLi₃₋ₓ)_{(3-y)/3}Y_{1-y}Zr_{y}Cl₆ (0<x<3; 0<y<1). The solid electrolyte may optionally include one or more additional electrolyte materials, such as where the solid electrolyte is a multi-component solid electrolyte comprising a first solid electrolyte that includes the compound (NaₓLi₃₋ₓ)_{(3-y)/3}Y_{1-y}Zr_{y}Cl₆ (0<x<3; 0<y<l) and/or the compound NaₓLi₃₋ₓYCl₆ (0<x<3) and a second electrolyte that is different from the first electrolyte.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1A is a schematic view of an example solid-state lithium-ion battery during discharge;

FIG. 1B is a schematic view of the example solid-state lithium-ion battery during charge;

FIG. 2A is a schematic view of an example solid-state sodium-ion battery during discharge; and

FIG. 2B is a schematic view of the example solid-state sodium-ion battery during charge.

FIG. 3 is a schematic view of an example hybrid solid-state battery capable of using both lithium ions and sodium ions as charge carriers.

FIG. 4 illustrates powder x-ray diffraction (XRD) results of tested Na_{0.75}Li_{1.5}Y_{0.25}Zr_{0.75}Cl₆ samples.

FIG. 5 illustrates ionic conductivities (room temperature) of various tested samples, including the compound Na_{0.75} Li_{1.5}Y_{0.25}Zr_{0.75}Cl₆ (shown as “MSFT”).

### DETAILED DESCRIPTION

### Introduction

In a conventional lithium-ion battery, the negative electrode includes lithium metal or a lithium metal alloy (often intercalated with a carbon matrix such as layers of graphite), and the positive electrode often includes a lithium metal oxide. The electrochemical roles of the electrodes reverse between anode and cathode, depending on the direction of current flow through the cell. Often, the designation of anode and cathode are made in reference to their functions during discharge. Accordingly, unless specified otherwise, the terms anode and cathode will refer to designations corresponding to discharge.

During discharge, lithium metal at the anode is oxidized in an oxidation half reaction to generate lithium ions and electrons. The electrons pass through the external circuit while the generated lithium ions pass through the electrolyte toward the cathode. At the cathode, the lithium ions that have passed through the electrolyte are combined with metal oxide in a reduction half reaction in which metal species of the metal oxide are reduced by electrons received at the cathode to generate lithium metal oxide.

The designations of anode and cathode are technically reversed during recharging of the battery. During recharging, the metal species of the lithium-metal oxide are oxidized to the metal oxide at the anode, releasing lithium ions that migrate through the electrolyte to the cathode where they are reduced to lithium metal.

A solid-state sodium-ion battery operates in a similar fashion, albeit with different materials. In a conventional sodium-ion battery, the negative electrode includes sodium metal or sodium metal alloy (often associated with a carbon matrix such as graphite), and the positive electrode often includes a sodium metal oxide. During discharge, sodium metal at the anode is oxidized in an oxidation half reaction to generate sodium ions and electrons. The electrons pass through the external circuit while the generated sodium ions pass through the electrolyte toward the cathode. At the cathode, the sodium ions that have passed through the electrolyte are combined with metal oxide in a reduction half reaction in which metal species of the metal oxide are reduced by electrons received at the cathode to generate sodium metal oxide. During recharging, the metal species of the sodium metal oxide are oxidized to the metal oxide at the anode, releasing sodium ions that migrate through the electrolyte to the cathode where they are reduced to sodium metal.

Unlike the liquid electrolytes or gel electrolytes used in non-solid ion batteries, a solid-state battery includes a solid electrolyte. Solid-state batteries can potentially provide improvements over conventional liquid or gel electrolyte batteries (including conventional liquid or gel electrolyte lithium-ion batteries), including better safety, thermal stability, energy density, power density, and/or a broader working temperature range. However, determining effective solid electrolyte materials is among the challenges in developing effective solid-state lithium-ion and/or sodium-ion batteries.

### Solid Electrolyte

Disclosed herein is the compound:

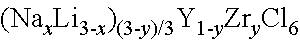

wherein x is greater than 0 and less than 3 and wherein y is greater than 0 and less than 1 (i.e., 0<x<3; 0<y<1). For example, where x=1 and y=0.75, the compound is:

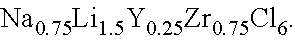

The disclosed compound can be utilized as an effective solid electrolyte for a solid-state battery. The disclosed compound can exhibit characteristics beneficial for solid-state battery electrolyte applications. Such characteristics include, for example, effective ionic conductivity (including room temperature conductivity), formability/ductility, oxidation/reduction stability, and compatibility with anode and cathode materials.

Other derivatives of the compound may additionally or alternatively be utilized as a solid electrolyte. Given the general formula NaₖLiₗYₘZrₙClₚ, values of k, l, m, n, and p can be selected to provide charge balance and a stable electrolyte structure. For example, values can be selected to be within: k<3; 0<l; m<1; 0<n; 0<p<6. Although particular examples disclosed herein relate to (NaₓLi₃₋ₓ)_{(3-y)/3}Y_{1-y}Zr_{y}Cl₆ (0<x<3; 0<y<1), including Na_{0.75}Li_{1.5}Y_{0.25}Zr_{0.75}Cl₆, it will be understood that related features and components (e.g., cathode materials, anode materials, etc.) can also be utilized with the other derivatives disclosed herein.

Because the solid electrolyte can conduct both lithium ions and sodium ions, it can be utilized as an effective solid electrolyte in a solid-state lithium-ion battery, in a solid-state sodium-ion battery, and/or in a hybrid solid-state battery capable of using both lithium and sodium ions as charge carriers.

The compound is presently believed to form a crystal structure corresponding to space group 18 (P2₁2₁2), which is within the orthorhombic crystal system (of the seven possible crystal systems). Other crystal structures may additionally or alternatively be possible.

In some embodiments, the solid electrolyte includes the compound (NaₓLi₃₋ₓ)_{(3-y)/3}Y_{1-y}Zr_{y}Cl₆ (0<x<3; 0<y<1) and omits or substantially omits other solid electrolyte compounds.

The solid electrolyte can also include one or more polymers. One or more polymers may be included, for example, to adjust manufacturing and/mechanical properties of the electrolyte, such as flexibility, shapeability, mechanical stability, and/or electrode compatibility. Examples of polymers that may be included in the electrolyte include those that suitably combine with the electrolyte compounds disclosed herein and/or that are known in the field of solid-state electrolytes, such as ether-based, ester-based, nitrile-based, polyvinylidene fluoride materials, and combinations thereof.

### Multi-Component Solid Electrolyte

The solid electrolyte may be a multi-component solid electrolyte. That is, the solid electrolyte can include a first section that includes a first solid electrolyte and a second section that includes a second, different solid electrolyte. The first solid electrolyte can be configured to interface with a first electrode (a lithium-based electrode or a sodium-based electrode) and the second electrolyte can be configured to interface with a second electrode (a lithium-based electrode or a sodium-based electrode). A multi-component solid electrolyte can beneficially minimize unwanted reactions at the interfaces with the respective contacting electrodes.

The first solid electrolyte can include the compound (NaₓLi₃₋ₓ)_{(3-y)/3}Y_{1-y}Zr_{y}Cl₆ (0<x<3; 0<y<1) as described above. The first solid electrolyte can additionally or alternatively include the compound NaₓLi₃₋ₓYCl₆ (0<x<3). This compound includes, for example, Na₂LiYCl₆, NaLi₂YCl₆, Na_{0.5}Li_{2.5}YCl₆, Na_{1.5}Li_{1.5}YCl₆, and Na_{2.5}Li_{0.5}YCl₆, and can have a trigonal ordered crystal structure such as with an R3̅ or P\hat{3}m1 space group. Additional details regarding the compound NaₓLi₃₋ₓYCl₆ (0<x<3) are found in U.S. patent application Ser. No. 18/669,330, which is incorporated herein by reference.

When formulated to interface with a lithium-based electrode, the second solid electrolyte can include a sulfide-based electrolyte material such as Li—P—S(e.g., Li₃PS₄, Li₇P₃S₁₁, Li₄P₂S₆), lithium argyrodites of formula Li₆PS₅X (where X is Cl, Br, or I), Li-M-P—S (where M is Ge, Sn, Si, or Al) (e.g., Li₁₀GeP₂S₁₂ (LGPS), Li₁₀SnP₂S₁₂, Li₁₀SiP₂S₁₂, Li₁₁AlP₂S₁₂), or combinations thereof. The second solid electrolyte can additionally or alternatively comprise other solid electrolyte materials for interfacing with lithium-based electrodes as known in the art, such as lithium lanthanum zirconium oxide (LLZO), lithium phosphorus oxynitride (LiPON), polymer electrolytes (e.g., polyethylene oxide doped with lithium salts), halide-based electrolytes (e.g., Li₃InCl₆, Li₃YCl₆), or combinations thereof.

### Solid-State Battery

The disclosed solid electrolyte can be included in a solid-state battery. Any of the features disclosed elsewhere herein regarding the solid electrolyte, including features related to a multi-component solid electrolyte, may be utilized in a solid-state battery and are applicable to the solid electrolyte disclosed in this section.

Because solid electrolytes disclosed herein can beneficially function to conduct lithium ions and/or sodium ions, a solid-state battery of the present disclosure can be configured as a lithium-ion battery, a sodium-ion battery, or a hybrid solid-state battery capable of using both lithium and sodium ions as charge carriers.

The solid-state battery may include a solid electrolyte that comprises the compound (NaₓLi₃₋ₓ)_{(3-y)/3}Y_{1-y}Zr_{y}Cl₆ (0<x<3; 0<y<1). In some embodiments, the solid-state battery comprises a solid electrolyte that includes the compound (NaₓLi₃₋ₓ)_{(3-y)/3}Y_{1-y}Zr_{y}Cl₆ (0<x<3; 0<y<1) and omits or substantially omits other solid electrolyte compounds.

The solid-state battery may include a multi-component solid electrolyte. For example, the solid-state battery may include a multi-component solid electrolyte comprising a first solid electrolyte that includes the compound (NaₓLi₃₋ₓ)_{(3-y)/3}Y_{1-y}Zr_{y}Cl₆ (0<x<3; 0<y<1) and/or the compound Na^{x}Li₃₋ₓYCl₆ (0<x<3) and a second electrolyte that is different from the first electrolyte. As disclosed above, the second electrolyte can be formulated to interface with a lithium-based electrode.

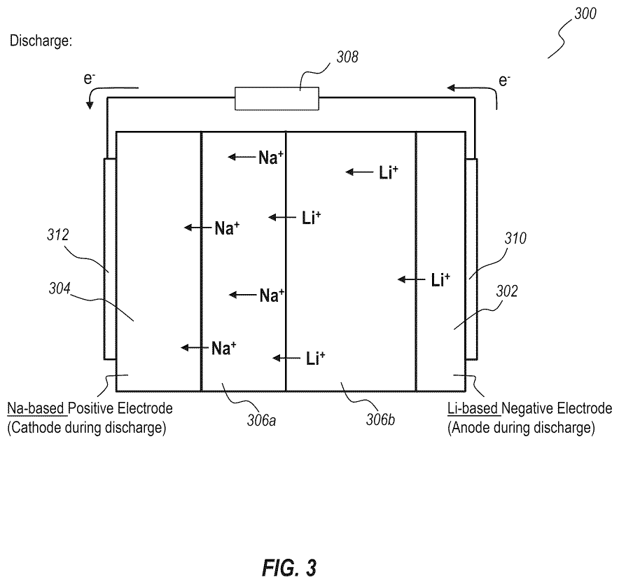

In some embodiments that include a multi-component solid electrolyte, the first solid electrolyte can be formulated to interface with a sodium-based electrode and the second solid electrode can be formulated to interface with a lithium-based electrode. Such a solid-state battery can be configured to operate with the lithium-based electrode as the anode and the sodium-based electrode as the cathode (see, e.g., the example hybrid solid-state battery illustrated in FIG. 3).

A solid-state battery as disclosed herein can additionally or alternatively include other solid-state electrolytes capable of conducting both lithium ions and sodium ions. For example, a solid-state battery can include a first electrode configured as a sodium-based electrode, a second electrode configured as a lithium-based electrode, and a solid electrolyte capable of conducting both lithium ions and sodium ions. The inclusion of a solid electrolyte capable of conducting both lithium ions and sodium ions, such as the solid electrolyte examples disclosed herein, enables the manufacture of batteries that balance the benefits of sodium-ion batteries and lithium-ion batteries. For example, such hybrid batteries can balance the higher relative conductivity and performance of lithium-ion batteries with the lower relative cost of sodium-ion batteries. Such a design can provide improved cost-effectiveness over lithium-ion only batteries while at the same time provide better performance (e.g., conductivity, energy density) than sodium-ion only batteries.

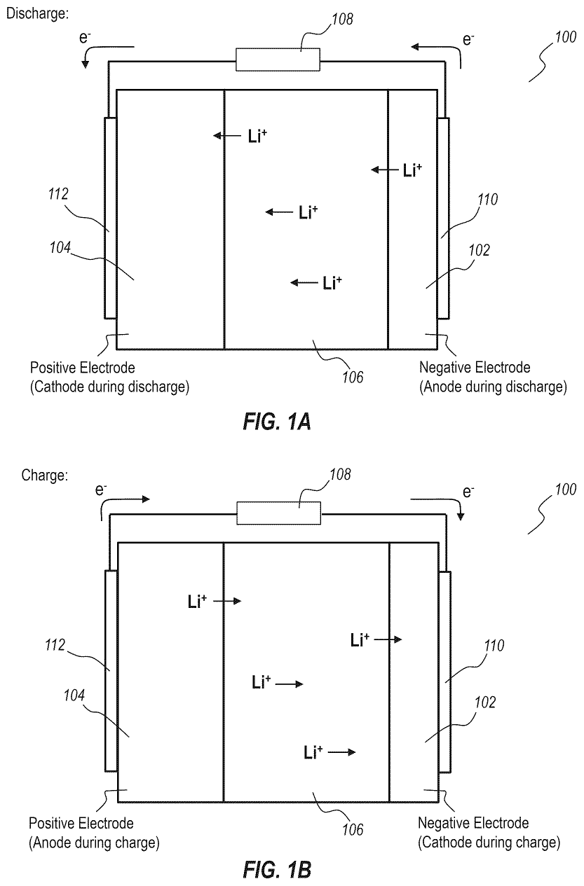

FIG. 1A is a schematic view of an example solid-state lithium-ion battery 100 during discharge, and FIG. 1B is a schematic view of the example solid-state lithium-ion battery 100 during charge.

As shown in FIG. 1A, the oxidation half reaction occurs at the negative electrode 102, generating lithium ions and electrons. The electrons pass through an external circuit 108 and the generated lithium ions pass through the solid electrolyte 106 toward the positive electrode 104. At the positive electrode 104, the lithium ions combine with the electrons in the reduction half reaction to form lithium-metal oxide. Current collectors 110 and 112 can also be included. The current collectors 110, 112 collect and distribute electrical current from the anode and cathode to the external circuit 108. The current collectors may be formed of suitable conductive materials such as copper and/or aluminum.

During charge, the lithium-metal oxide at the positive electrode 104 is oxidized to generate lithium ions and electrons. The generated lithium ions pass through the solid electrolyte 106 toward the negative electrode 104. At the negative electrode 102, the lithium ions combine with the electrons in the reduction half reaction to form lithium metal.

The solid electrolyte 106 can exhibit characteristics beneficial for solid-state battery electrolyte applications. Such characteristics include, for example, effective ionic conductivity (including room temperature conductivity), formability/ductility, oxidation/reduction stability, and compatibility with anode and cathode materials.

The materials used in the electrodes can include any suitable electrode materials or combinations thereof known in the art for use in solid-state lithium-ion batteries. Example anode materials include lithium metal, lithium alloy (e.g., Li—In, Li—Sn, Li—Si), lithium titanate (e.g., oxides such as Li₄₇Ti₅O₁₂), other metal oxides (e.g., SnO₂, TiO₂), carbon materials (e.g., graphite, carbon nanotubes, graphene), silicon, and combinations thereof. Some embodiments may omit an anode and use a current collector in direct conductive contact with the solid electrolyte.

Example cathode materials include metal oxides such as: LiₓMO₂ where M is Fe, Mn, Co, Ni, or Ti (e.g., LiCoO₂, LiNiO₂, LiMn₂O₄); lithium nickel manganese cobalt oxides (NMCs) such as LiNiₓMn_{y}Co_{1-x-y}O₂; lithium nickel cobalt aluminum oxides (NCAs) such as LiNiₓAl_{y}Co_{1-x-y}O₂; and combinations thereof. The cathode can additionally or alternatively include: sulfur-based materials (e.g., Li₂S); metal sulfides (e.g., sulfides of Ag, Co, Cu, Fe, Ni); carbon materials (e.g., graphite, carbon nanotubes, graphene) or composites of carbon materials with other materials such as sulfur-based materials; phosphate-based materials (e.g., LiFePO₄); and combinations thereof.

Because the solid electrolyte can conduct lithium ions and sodium ions, it can be utilized as an effective solid electrolyte in solid-state lithium-ion batteries, in solid-state sodium-ion batteries, and/or in hybrid solid-state batteries capable of using both lithium and sodium ions as charge carriers. Sodium-ion batteries do not typically provide the same energy density as lithium-ion batteries. However, sodium-ion batteries can be more sustainable and cost-effective for certain applications, particularly where the lower energy density can be adequately compensated by larger battery sizes. Moreover, sodium may be less prone to forming dendrites than lithium and/or may be less affected by lower temperatures, which can make sodium-ion batteries more beneficial in certain applications.

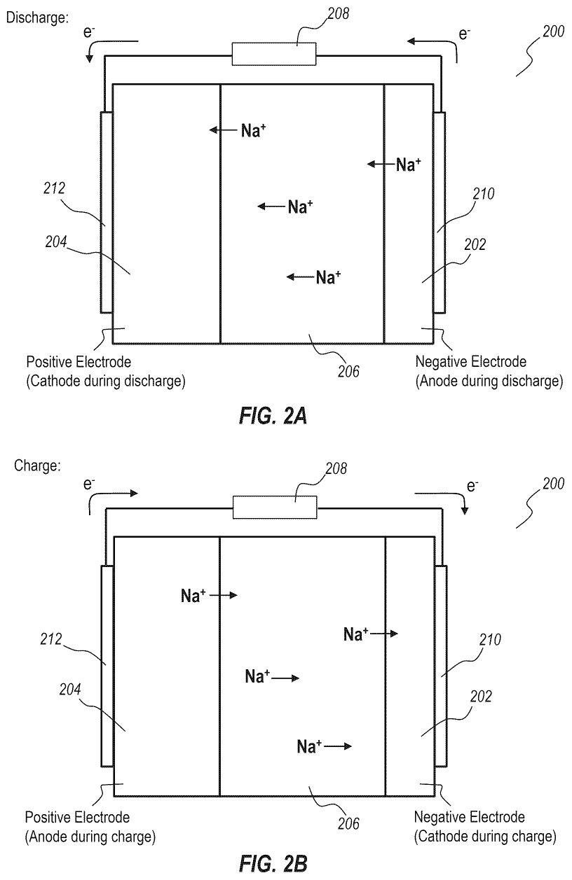

FIG. 2A is a schematic view of an example solid-state sodium-ion battery during discharge, and FIG. 2B is a schematic view of the example solid-state sodium-ion battery during charge.

As shown in FIG. 2A, the oxidation half reaction occurs at the negative electrode 202, generating sodium ions and electrons. The electrons pass through an external circuit and the generated sodium ions pass through the solid electrolyte 206 toward the positive electrode 204. At the positive electrode 204, the sodium ions combine with the electrons in the reduction half reaction. Current collectors 210 and 212 can also be included to collect and distribute electrical current from the anode and cathode to the external circuit 208. The current collectors may be formed of suitable conductive materials such as copper and/or aluminum.

During charge, materials at the positive electrode 204 are oxidized to generate sodium ions and electrons. The generated sodium ions pass through the solid electrolyte 206 toward the negative electrode 204. At the negative electrode 202, the sodium ions combine with the electrons in the reduction half reaction.

The solid electrolyte 206 can exhibit characteristics beneficial for solid-state battery electrolyte applications. Such characteristics include, for example, effective ionic conductivity (including room temperature conductivity), formability/ductility, oxidation/reduction stability, and good compatibility with anode and cathode materials.

The materials used in the electrodes can include any suitable electrode materials or combinations thereof known in the art for use in solid-state sodium-ion batteries. Example anode materials include sodium metal, sodium metal alloys (e.g., Na—K, Na—Pb), carbon materials (e.g., hard carbon, graphite, carbon nanotubes, graphene, carbon arsenide), tin-based materials, sulfides (e.g., MoS₂, TiS₂), transition metal oxides (e.g., titanates such as Na₂Ti₃O₇, manganates such as Na₄Mn₉O₁₈), and combinations thereof. Some embodiments may omit an anode and use a current collector in direct conductive contact with the solid electrolyte.

Example cathode materials include metal oxides such as: NaₓMO₂ where M is Fe, Mn, Co, Ni, or Ti (e.g., NaCoO₂, NaNiO₂, NaMn₂O₄, Na₄Mn₉O₁₈, Na₂Ti₃O₇); sodium NMCs such as NaNiₓMn_{y}Co_{1-x-y}O₂; sodium NCAs such as NaNiₓAl_{y}Co_{1-x-y}O₂; and combinations thereof. The cathode can additionally or alternatively include: sulfide-based materials (e.g., Na₂S); metal sulfides (e.g., sulfides of Ag, Co, Cu, Fe, Ni); carbon materials (e.g., graphite, carbon nanotubes, graphene) or composites of carbon materials with other materials such as with sulfur-based materials; phosphate-based materials (e.g., NaFePO₄, Na₂FeP₂O₇, Na₃V₂(PO₄)₃, NaV(PO₄)F); Prussian blue/white analogs (e.g., NaₓFe[Fe(CN)₆] where x can be 0, 1, or 2); and combinations thereof.

A hybrid solid-state battery capable of using both lithium-ions and sodium-ions as charge carriers can beneficially combine advantages of both lithium-ion and sodium-ion batteries. For example, by incorporating the high conductivity of lithium-ions and the cost-effectiveness of sodium, a hybrid solid-state battery can achieve a desirable balance between performance (e.g., conductivity, energy density) and safety/cost. Such a battery can combine any of the electrode materials disclosed herein for lithium-ion solid state batteries with any of the electrode materials disclosed herein for sodium-ion solid state batteries.

FIG. 3 is a schematic view of an example hybrid solid-state battery 300 during discharge. In this example, the battery 300 includes a lithium-based anode 302 and a sodium-based cathode 304. In this example, the battery 300 also includes a multi-component solid electrolyte that includes a first solid electrolyte 306a and a second solid electrolyte 306b. Other configurations of battery 300 can include different solid electrolytes as disclosed herein. For example, the electrolyte need not be a multi-component solid electrolyte.

During discharge, the oxidation half reaction at the anode 302 generates lithium ions and electrons. The electrons pass through an external circuit 308 and the generated lithium ions pass through the second solid electrolyte 306b toward the first solid electrolyte 306a. Because the first solid electrolyte 306a can function with both sodium and lithium ions, the lithium ions can induce movement of the sodium ions from the first solid electrolyte 306a to the cathode 304. At the cathode 304, the sodium ions combine with the electrons in the reduction half reaction. Current collectors 310 and 312 can also be included to collect and distribute electrical current from the anode and cathode to the external circuit 308. The current collectors may be formed of suitable conductive materials such as copper and/or aluminum. During charge (not shown), the movements of the electrons and charge carriers are reversed.

The batteries 100, 200, 300 can also include a container (not shown). The container can be any container suitable for the intended application of the solid-state battery. The container can include metal (e.g., stainless steel, aluminum) and/or polymer materials. The container functions as a physical housing or casing to hold the anode, cathode, and electrolyte in proper position, and to provide mechanical support, electrical insulation, and/or thermal insulation.

The container can further include various sealing and/or barrier materials to prevent the ingress of moisture or contaminants. The container can further include various insulating layers (e.g., formed from ceramics and/or glass) for electrical insulation of the internal components. The container can further include various components for managing thermal loads and preventing overheating, such as heat sink components, thermal interface materials, and thermal insulators.

The solid electrolyte of the solid-state battery can also include one or more dopants. The one or more dopants can be added to improve ionic conductivity of the electrolyte, modify vacancies in the electrolyte, influence the crystal structure of the electrolyte, promote structural stability of the electrolyte, promote thermal stability of the electrolyte, and/or affect grain boundaries within the electrolyte. Example dopants include La, Ca, Ni, Co, Gd, Pr, Mg, Al, Sr, Ti, Si, Ge, and/or Sn.

### Compound Synthesis

The compound (NaₓLi₃₋ₓ)_{(3-y)/3}Y_{1-y}Zr_{y}Cl₆ (0<x<3; 0<y<1) and/or the compound NaₓLi₃₋ₓYCl₆ (0<x<3) can be synthesized using methods known in the art for synthesizing alkali metal and rare-earth metal halides. That is, the skilled person can readily adapt known synthesis methods for other alkali metal and rare-earth metal halides to the compounds disclosed herein.

See, for example: the solid-state synthesis reaction described by Ito et al. “Kinetically Stabilized Cation Arrangement in Li3YCl6 Superionic Conductor during Solid-State Reaction” (Adv. Sci. 2021, 8, 210413); the wet chemistry method described by Wang et al. “A universal wet-chemistry synthesis of solid-state halide electrolytes for all-solid-state lithium-metal batteries” (Science Advances 2021, vol. 7, issue 37); the solid-state and mechanochemical synthesis methods described by Schlem et al. “Insights into the Lithium Sub-structure of Superionic Conductors Li3YCl6 and Li3YBr6” (Chem. Mater. 2021, 33, 1, 327-37); and/or the synthesis described by Hu et al. “Revealing the Pnma crystal structure and ion-transport mechanism of the Li3YCl6 solid electrolyte” (Cell Reports Physical Science 4, 101428).

Generally, synthesis of the disclosed compound can be carried out by mixing stoichiometrically appropriate amounts of suitable precursor components (e.g., NaCl, LiCl, ZrCl₄, and YCl₃). The precursor mixture can be subjected to mechanical processing, such as ball milling and/or other suitable processing techniques (e.g., attrition milling, jet milling, vibration milling, hammer milling, roller milling, colloid milling, cryogenic milling, ultrasonic milling, pin milling, and/or manual techniques such as mortar and pestle grinding). Optionally, a suitable volatile organic liquid, such as acetone and/or an alcohol, may be added to the mixture to aid in homogenization.

Subsequently, the processed precursor mixture can be subjected to heat treatment to initiate and carry out the solid-state reaction. The heat treatment can be carried out in an appropriate container formed from materials that are substantially chemically inert to the reactants at the heating temperatures used. Example materials include suitable metals such as noble metals. The processed precursor material may optionally be pelletized prior to heat treatment.

The heat treatment may be carried out at a temperature and time sufficient to carry out the solid-state reaction, such as a temperature of about 500° C. with a suitable heating rate such as about 10° C./min. The annealing reaction can be carried out for a suitable time period, such as about 24 hours. The heat treatment temperature can be carried out at a temperature of 300° C. or more, 400° C. or more, 500° C. or more, 600° C. or more, such as up to 700° C., 800° C., 900° C., or 1,000° C., or may be carried out at a temperature within a range with endpoints defined by any two of the foregoing values. The heat treatment duration can be at least 3 hours, at least 6 hours, at least 12 hours, at least 18 hours, at least 24 hours, such as up to 48 hours or more, or for a duration within a range using any of the foregoing as endpoints.

Following heat treatment, the material may undergo further mechanical processing, such as undergoing any one or more of the mechanical processing techniques recited above.

The resulting product may be analyzed using analytical methods known in the art. Examples include X-ray diffraction (XRD), scanning electron microscopy (SEM), transmission electron microscopy (TEM), atomic force microscopy (AFM), nuclear magnetic resonance (NMR) spectroscopy, Fourier transform infrared (FTIR) spectroscopy, Raman spectroscopy, differential scanning calorimetry (DSC), X-ray photoelectron spectroscopy (XPS), and electron paramagnetic resonance (EPR).

### Battery Manufacture & Use

Also disclosed herein is a method of manufacturing a solid-state battery, such as a solid-state lithium-ion battery, a solid-state sodium-ion battery, or a hybrid solid-state battery. The method comprises: placing a positive electrode within a container; placing a negative electrode within the container; and placing a solid electrolyte within the container between and in conductive contact with the positive electrode and the negative electrode. The solid electrolyte can comprise the compound (NaₓLi₃₋ₓ)_{(3-y)/3}Y_{1-y}Zr_{y}Cl₆ (0<x<3; 0<y<1). The solid electrolyte may optionally include one or more additional electrolyte materials. For example, the solid electrolyte may be a multi-component electrolyte. The multi-component solid electrolyte can comprise a first solid electrolyte that includes the compound (NaₓLi₃₋ₓ)_{(3-y)/3}Y_{1-y}Zr_{y}Cl₆ (0<x<3; 0<y<1) and/or the compound NaₓLi₃₋ₓYCl₆ (0<x<3) and a second electrolyte that is different from the first electrolyte. As disclosed above, the second electrolyte can be formulated to interface with a lithium-based electrode.

The container can be any container suitable for the intended application of the solid-state battery. The container functions as a physical housing or casing to hold the anode, cathode, and electrolyte in proper position, and to provide mechanical support, electrical insulation, and/or thermal insulation. The container can include any of the components as described elsewhere herein.

The solid-state batteries may be used in any application amenable to battery power. Examples include consumer electronic devices such as laptop computers, mobile phones, and tablets; wearable devices such as smart watches and other fitness tracking devices; implantable medical devices such as pacemakers and neurostimulators; electric vehicles (e.g., cars, bikes, scooters), unmanned aerial vehicles (UAVs) including drones, grid and/or renewable (e.g., solar, wind) excess energy storage, electric tools, and any other application where battery power is suitable.

### Working Examples

### Synthesis of Na_{0.75}Li_{1.5}Y_{0.25}Zr_{0.75}Cl₆

All reagents and product materials were handled in a dry (<0.5 ppm water, <0.5 ppm oxygen) Ar-filled glovebox. The reagents of LiCl (vacuum-dried), NaCl, YCl₃, and ZrCl₄ were weighed out in stoichiometric ratios, hand ground/mixed in an agate mortar and pestle, then loaded as a loose powder in a dried quartz ampoule which was evacuated and flame-sealed. The reactions were loaded into a tube furnace with a protective Ar-flow (in case of leaks) and heated to 500° C. at a rate of 10° C./min then annealed at 500° C. for 24 hours. The reactions were naturally cooled. The skilled person can readily vary stoichiometric ratios of precursor materials to develop other compounds according to (NaₓLi₃₋ₓ)_{(3-y)/3}Y_{1-y}Zr_{y}Cl₆ (0<x<3; 0<y<1).

### XRD Characterization:

All powder X-ray diffraction (PXRD) measurements were conducted on a Rigaku Miniflex 600G diffractometer with a Cu source (λ=1.5418 Å) placed inside a nitrogen-purged and dried glovebox to avoid moisture degradation of samples. Samples were placed in a Si zero background well holder.

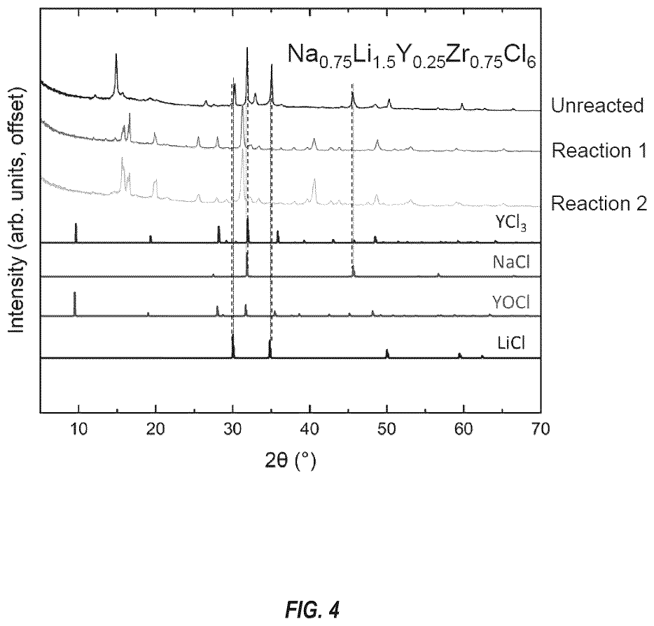

XRD results are shown in FIG. 4. The synthesis reactions for the solid electrolyte Na_{0.75}Li_{1.5}Y_{0.25}Zr_{0.75}Cl₆ (“Reaction 1” and “Reaction 2”) showed no remaining binary impurity phases. That is, the XRD peaks indicative of YCl₃, NaCl, YOCl, and LiCl were not present on the solid electrolyte XRD results, as indicated by the dashed lines.

### Ionic Conductivity Characterization:

Ionic conductivity measurements were determined using electrochemical impedance spectroscopy (EIS) measurements. The Na_{0.75}Li_{1.5}Y_{0.25}Zr_{0.75}Cl₆ electrolytes were hand-ground with agate mortar and pestle for 15 minutes and then subsequently ball-milled for 10 minutes with 5-mm diameter ZrO₂ balls with a mass ratio of 10:1. The milling was stopped routinely to scrape the sides of the container every 3 or 4 minutes, ensuring a more even mixing.

Using a 12-mm diameter PEEK split cell inserted within a controllable temperature sleeve (MSE Supplies, USA), 110 mg of fine electrolyte powder were sandwiched between stainless steel (SS) spacers on both sides (SS|SE|SS). The entire split cell was pressed at 100 bar on hydraulic press (Across International, Model MP24A).

Once pressed, the cell was placed in a stainless-steel jig with a pressure sensor. The electrochemical impedance spectroscopy was collected using potentiostat (Gamry 620) at various pressure between 1.5-3 tons applied on the cells. The EIS spectra were collected with sinusoidal amplitude of 100 mV and a frequency range of 6 MHz to 10 Hz. The cell was run at temperatures from 20° C. to 80° C. at 20° C. intervals, making sure to have at least 3 identical EIS scans before increasing to the next temperature step. At each temperature, the cell was rested for 1 h to establish a stable temperature. To determine the ionic conductivity of the cell, the thickness of the SE pellet was also measured using a Mitutoyo QuantuMike micrometer after removal from the cell.

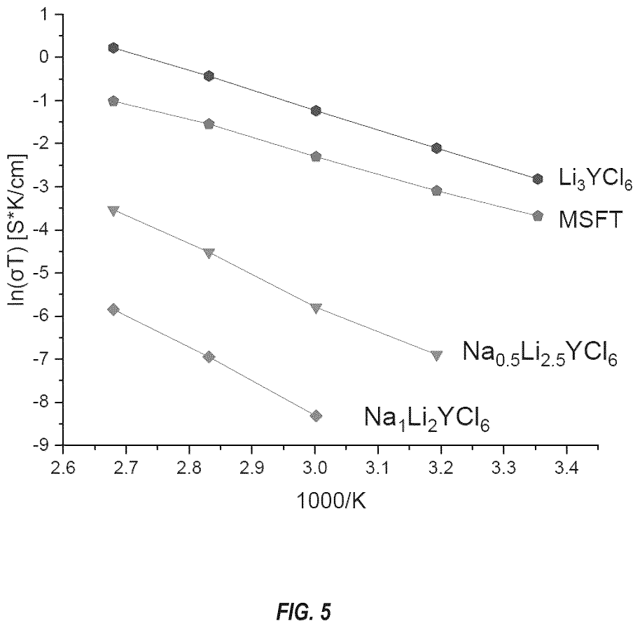

Ionic conductivity (room temperature) results are indicated in FIG. 5 in the form of an Arrhenius plot. In FIG. 5, “MSFT” represents the compound Na_{0.75}Li_{1.5}Y_{0.25}Zr_{0.75}Cl₆.

### Additional Terms & Definitions

All publications (including patents, patent applications, journal articles, etc.) recited herein are incorporated herein by reference.

As used herein, “conductive contact” and similar terms mean contact that is sufficient for passage of electrons and/or charge-carrier ions along at least a portion of the interface between the two or more components in conductive contact. Such contact will usually, but not necessarily, involve direct mechanical contact.

The embodiments disclosed herein should be understood as comprising/including disclosed components and may therefore include additional components not specifically described. However, any feature positively disclosed herein may optionally be expressly omitted (essentially omitted or completely omitted, as defined herein) in the claims.

Optionally, non-disclosed components may be completely omitted or essentially omitted from the disclosed embodiments. For example, a solid electrolyte may essentially omit or completely omit electrolyte compounds not specifically disclosed herein, including any electrolyte with a different compound formula. Similarly, the disclosed solid-state electrolyte may essentially omit or completely omit one or more elements not specifically disclosed as being part of the electrolyte compound. For example, the disclosed solid-state electrolyte may essentially omit or completely omit one or more of Be, Sc, Cs, Rb, Ti, Hf, Ta, Ca, Sr, Mg, or Fe.

An embodiment that “essentially omits” a component may include trace amounts and/or non-functional amounts of the component. For example, an “essentially omitted” component may be included in an amount no more than 1%, no more than 0.5%, no more than 0.1%, or no more than 0.01% by total weight of the relevant composition (e.g., by total weight of the solid electrolyte).

A composition that “completely omits” a component does not include a detectable amount of the component (i.e., does not include an amount above any inherent background signal associated with an appropriate testing instrument) when analyzed using standard compositional analysis techniques such as, for example, microscopy imaging techniques, chromatographic techniques (e.g., thin-layer chromatography (TLC), gas chromatography (GC), liquid chromatography (LC)), or spectroscopy techniques (e.g., Fourier transform infrared (FTIR) spectroscopy).

In addition, unless otherwise indicated, numbers expressing quantities, constituents, distances, or other measurements used in the specification and claims are to be understood as optionally being modified by the term “about.” Notwithstanding the foregoing, removal of the term “about” from a claimed feature will be understood to indicate that the term no longer modifies that feature. When the terms “about,” “approximately,” “substantially,” or the like are used in conjunction with a stated amount, value, or condition, it may be taken to mean an amount, value or condition that deviates by less than 10%, less than 5%, less than 1%, less than 0.1%, or less than 0.01% of the stated amount, value, or condition.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent may also include two or more such referents.

It will also be appreciated that embodiments described herein may also include properties and/or features described in one or more separate embodiments and are not necessarily limited strictly to the features expressly described for that particular embodiment. Accordingly, one or more features of a given embodiment can be combined with and/or incorporated into other embodiments of the present disclosure. Accordingly, any of the originally presented claims can be amended to incorporate elements of any other claim(s), regardless of the specific dependency structure of the originally presented claims, except where such features are clearly mutually exclusive. Thus, although an originally presented claim may have a specific claim dependency, the claim will be understood, for purposes of supporting disclosure, as though it depends from “any preceding claim,” except where antecedent basis and/or mutually exclusive features dictate otherwise.

1. A solid electrolyte comprising the compound: 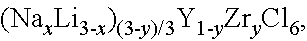
wherein x is greater than 0 and less than 3, and
wherein y is greater than 0 and less than 1.

2. The solid electrolyte of claim 1, wherein x=0.75 and y=0.75 and the solid electrolyte comprises the compound Na_{0.75} Li_{1.5}Y_{0.25}Zr_{0.75} Cl₆.

3. The solid electrolyte of claim 1, wherein the solid electrolyte is a multi-component solid electrolyte, wherein a first solid electrolyte of the multi-component solid electrolyte comprises the compound (Na_{X}Li₃₋ₓ)_{(3-y)/3}Y_{1-y}Zr_{y}Cl₆ and wherein a second solid electrolyte of the multi-component solid electrolyte is different from the compound (NaₓLi₃₋ₓ)_{(3-y)/3}Y_{1-y}Zr_{y}Cl₆.

4. The solid electrolyte of claim 3, wherein the first solid electrolyte and the second solid electrolyte are arranged in distinct sections of the multi-component solid electrolyte.

5. The solid electrolyte of claim 1, further comprising one or more dopants.

6. The solid electrolyte of claim 5, wherein the one or more dopants comprise La, Ca, Ni, Co, Gd, Pr, Mg, Al, Sr, Ti, Si, Ge, Sn, or combination thereof.

7. The solid electrolyte of claim 1, wherein the compound (NaₓLi₃₋ₓ)_{(3-y)/3}Y_{1-y}Zr_{y}Cl₆ substantially omits dopants.

8. A method of using a solid electrolyte, the method comprising:
providing an electric potential between a first point and a second point,
wherein a solid electrolyte is disposed between the first point and the second point,
wherein the solid electrolyte comprises the compound: 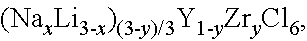
wherein x is greater than 0 and less than 3, and
wherein y is greater than 0 and less than 1.

9. The method of claim 8, further comprising passing lithium ions and/or sodium ions within the solid electrolyte.

10. The method of claim 9, comprising passing both lithium ions and sodium ions within the solid electrolyte.

11. The method of claim 8, wherein x=0.75 and y=0.75 and the solid electrolyte comprises the compound Na_{0.75}Li_{1.5}Y_{0.25}Zr_{0.75}Cl₆.

12. The method of claim 8, wherein the solid electrolyte is a multi-component solid electrolyte, wherein a first solid electrolyte of the multi-component solid electrolyte comprises the compound (NaₓLi₃₋ₓ)_{(3-y)/3}Y_{1-y}Zr_{y}Cl₆ and wherein a second solid electrolyte of the multi-component solid electrolyte is different from the compound (NaₓLi₃₋ₓ)_{(3-y)/3}Y_{1-y}Zr_{y}Cl₆.

13. The method of claim 12, wherein the first solid electrolyte and the second solid electrolyte are arranged in distinct sections of the multi-component solid electrolyte.

14. The method of claim 8, wherein the solid electrolyte further comprises one or more dopants.

15. The method of claim 14, wherein the one or more dopants comprise La, Ca, Ni, Co, Gd, Pr, Mg, Al, Sr, Ti, Si, Ge, Sn, or combination thereof.

16. The method of claim 8, wherein the compound (NaₓLi₃₋ₓ)_{(3-y)/3}Y_{1-y}Zr_{y}Cl₆. substantially omits dopants.

17. A method of manufacturing a solid electrolyte material, the method comprising:
mixing precursor materials to form a precursor mixture; and
subjecting the precursor mixture to a solid-state reaction to form: 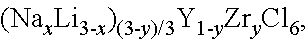
wherein x is greater than 0 and less than 3, and
wherein y is greater than 0 and less than 1.

18. The method of claim 17, wherein the precursor materials comprise chloride salts of sodium, lithium, zirconium, and yttrium.

19. The method of claim 18, wherein the precursor materials comprise NaCl, LiCl, ZrCl₄, and YCl₃.

20. The method of claim 17, wherein the precursor materials are mixed in a stoichiometric ratio such that the solid-state reaction forms Na_{0.75}Li_{1.5}Y_{0.25}Zr_{0.75}Cl₆.
